(19) United States
(12) Patent Application Publication
(10) Pub. No.: US 2013/0212834 A1
(43) Pub. Date: Aug. 22, 2013

(54) CASTER ASSEMBLY

(71) Applicant: Ching-Tsun Chen, Changhua County (TW)

(72) Inventor: Ching-Tsun Chen, Changhua County (TW)

(21) Appl. No.: 13/399,545

(22) Filed: Feb. 17, 2012

(51) Int. Cl. B60B 33/00

(52) U.S. Cl. 16/45

(57) ABSTRACT

A caster assembly of the present invention includes a fixation base, a rotary base which is rotatably disposed on the fixation base, a wheel which is rotatably disposed on the rotary base, and a brake mechanism. The brake mechanism is disposed on the rotary base. The brake mechanism can be activated to abut against the wheel and the fixation base, so that rotations of the rotary base and the wheel are obstructed. Thus, stably fixation function is provided.

### BACKGROUND OF THE INVENTION

1. Field of the Invention

The present invention relates to a caster provided on table, chair, or luggage box for moving.

2. Description of the Prior Art

Caster is usually provided on (under, exactly) furniture for supporting and moving purpose. For fixation purpose, casters are usually provided with brake. Unexpected movement caused by relief or external force is then prevented.

However, unexpected movement can not be completely expelled by the mere brake. When brake of the caster is activated, wheel of the caster is prevented from only rolling. The wheel can still spin if suitable external force is exerted thereon. Therefore, the caster and the object carried would be unstable even the brake is activated.

The present invention is, therefore, arisen to obviate or at least mitigate the above mentioned disadvantages.

### SUMMARY OF THE INVENTION

The main object of the present invention is to provide a brake to a caster to prevent both rolling and spinning of wheel of the caster.

To achieve the above and other objects, a caster assembly of the present invention includes a fixation base, a rotary base, a wheel, and a brake mechanism.

The rotary base is rotatably disposed on the fixation base. The rotary base is able to rotate about a non-horizontal axis.

The wheel is rotatably disposed on the rotary base. The wheel is able to rotate about a horizontal axis.

The brake mechanism is disposed on the rotary base. The brake mechanism is used for selectively abutting against the fixation base and the wheel, so that the rotary base and the wheel are unable to rotate.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a first embodiment of the present invention;

FIG. 2 is a breakdown drawing showing a first embodiment of the present invention;

FIG. 3 is a stereogram showing partial components of a first embodiment of the present invention;

FIG. 4 is a breakdown drawing showing partial components of a first embodiment of the present invention;

FIG. 5 is a stereogram showing a component of a first embodiment of the present invention;

FIG. 6 is a breakdown drawing of a rotary base of a first embodiment of the present invention;

FIG. 7 is a stereogram of a lever of a first embodiment of the present invention;

FIG. 8 is a cross sectional profile of a first embodiment of the present invention;

FIG. 9 is a profile of a first embodiment of the present invention;

FIG. 10 is diagram showing an activated condition of a first embodiment of the present invention.

### DETAILED DESCRIPTION OF THE PREFERRED EMBODIMENTS

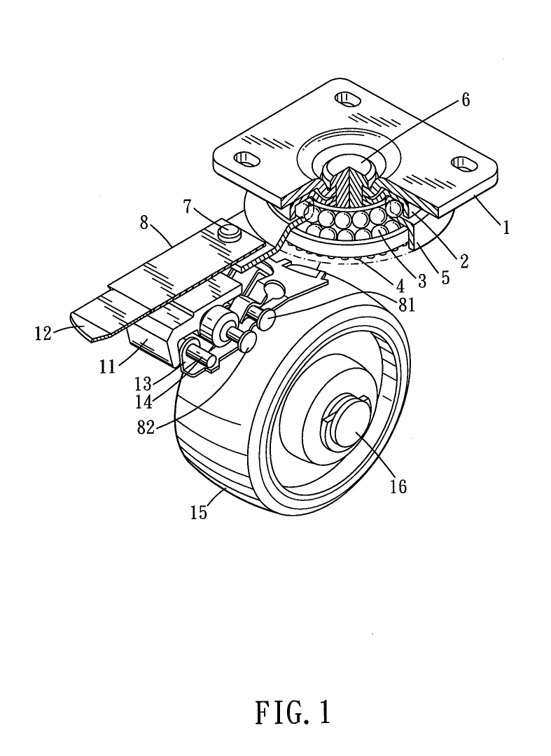

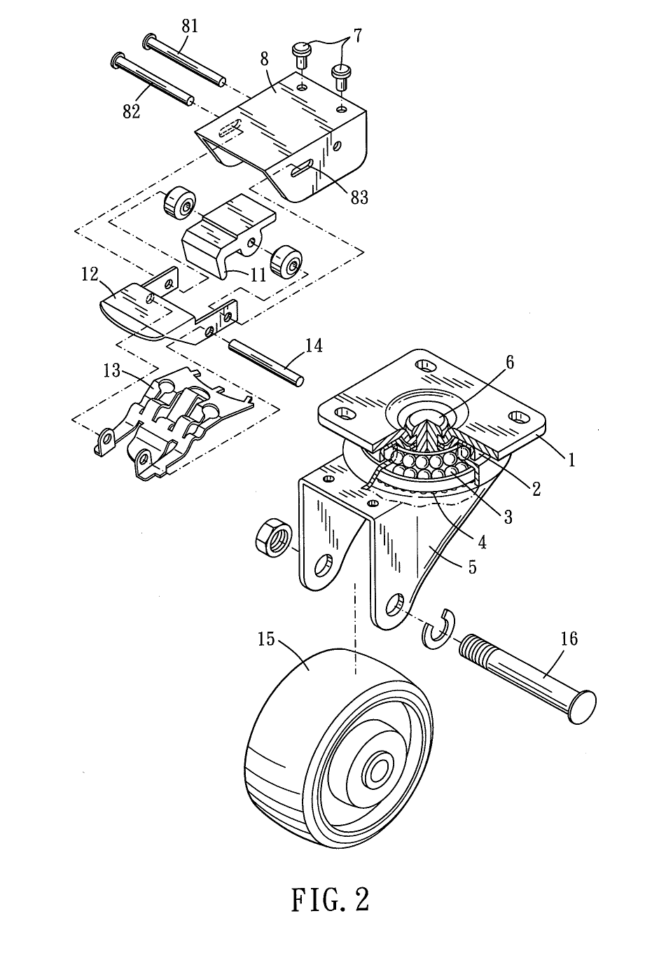

Please refer to FIG. 1 and FIG. 2 for a first embodiment of the present invention. The caster assembly of the present embodiment is provided for wagon, carriage, luggage box, table, or chair. Supporting and moving smoothly is then achieved. The caster assembly includes a fixation base 1, a rotary base, a wheel 15, and a break mechanism.

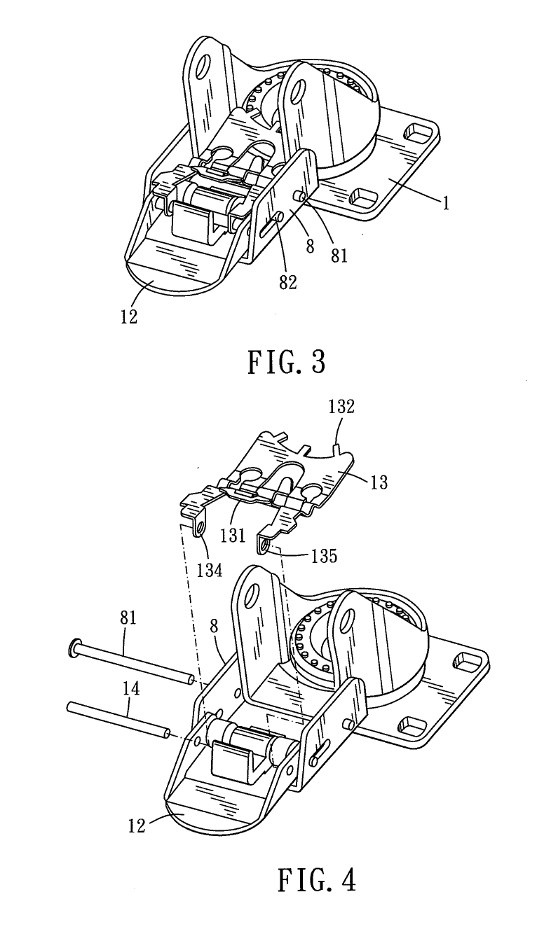

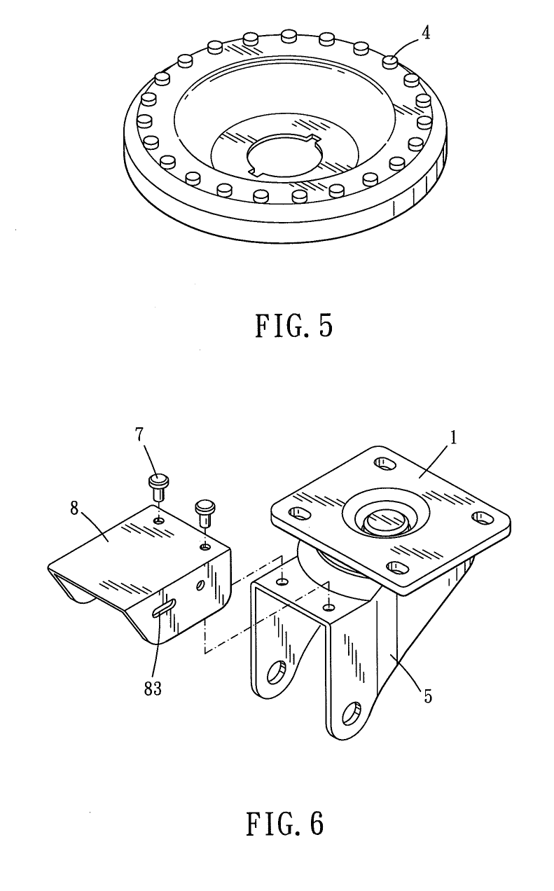

The fixation base 1 is provided for being mounted to other objects, such as wagon or carriage. Therefore, the fixation base 1 is formed with several fixation holes which are provided for screws or rivets to penetrate therethrough. The fixation base 1 is further provided with bearing 2, 3 which is suitable for burdening vertical pressing force. The fixation base 1 is provided with protrusions 4 on the bottom thereof. As shown in FIG. 3 to FIG. 5, the protrusions 4 are spaced from others and are annularly arranged. Gaps are defined between any two adjacent protrusions 4.

Please refer to FIG. 1. The rotary base is rotatably disposed on the fixation base 1. Thus, the rotary base is able to rotate about a non-horizontal axis 6. Preferably, the axis 6 is vertical, being centrally surrounded by the protrusions 4. In other words, the protrusions 4 are annularly arranged about the axis 6. The rotary base is disposed on the bearing 2, 3, so that the rotary base is able to smoothly rotate with respect to the fixation base 1. Please refer to FIG. 2 and FIG. 6. In the present embodiment, the rotary base includes a frontal shell 5 and a rear shell 8. The frontal shell 5 is rotatably disposed on the fixation base 1. The frontal shell 5 has horizontal axis defined by a horizontal shaft 16. The rear shell 8 is disposed on the frontal shell 5. The rear shell 8 has a support shaft 81 and a shifting shaft 82. The support shaft 81 and the shifting shaft 82 are parallel to the horizontal shaft 16. The rear shell 8 is further formed with sliding grooves 83. The shifting shaft 82 is located in the sliding grooves 83, so that the shifting shaft 82 is able to slide along the sliding grooves 83 horizontally between an inner position and an outer position. The rear shell 8 is mounted to the frontal shell 5 by rivets 7.

Please refer to FIG. 1 and FIG. 2. The wheel 15 is rotatably disposed on the rotary base, and is able to rotate about the horizontal axis defined by the horizontal shaft 16. More particularly, the wheel 15 is rotatably disposed on the horizontal shaft 16, making the shaft 16 an axle.

The brake mechanism is disposed on the rotary base. The brake mechanism is used for selectively abutting against the fixation base 1 and the wheel 15. Thus, both of the rotary base and the wheel 15 are unable to rotate when the brake mechanism is activated. In other words, under the condition that the brake mechanism is activated, the rotary base is unable to rotate relative to the fixation base 1, and the wheel 15 is unable to rotate relative to the rotary base. More particularly, the brake mechanism includes a lever 13, a presser 12, and a shifting member 11.

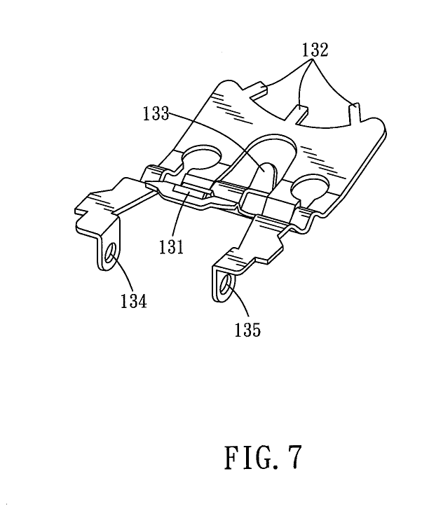

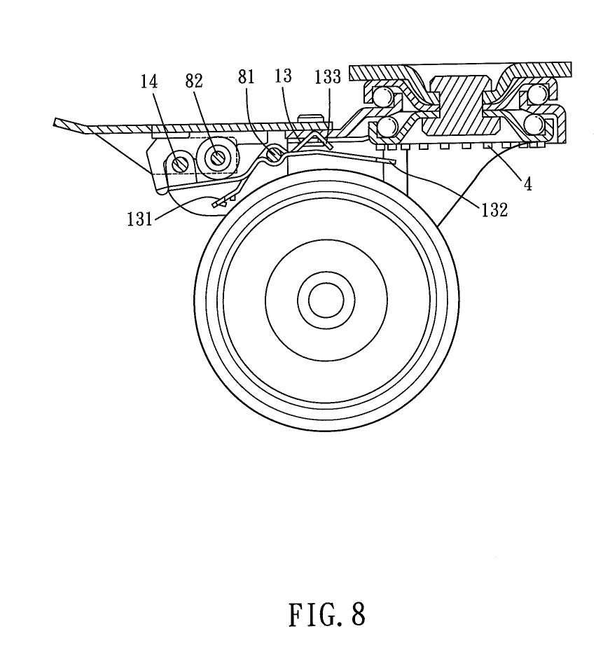

The lever 13 is pivoted on the support shaft 81, so that the lever 13 is able to be shifted between a first position and a second position. Motion of the lever 13 may be caused by rotation of the lever 13 relative to the shaft 81, or by rotation of the shaft 81 relative to the rear shell 8. The lever 13 is bent and formed from a metal sheet to obtain flexibility and elasticity thereon. Please refer to FIG. 2, FIG. 7, and FIG. 8, the lever 13 has an abutting portion 131 and an engaging portion 132. The support shaft 81 is located between the abutting portion 131 and the engaging portion 132. In addition, the lever 13 has a positioning portion 133 and a connecting portion extending therefrom. The connecting portion includes two arms 134, 135 extending from two sides of the lever 13. The positioning portion 133 abuts against the rotary base. As shown in FIG. 8, the positioning portion 133 provides an elastic force to keep the lever 13 generally locate at the first position. The support shaft 81 is parallel to the horizontal shaft 16, so that the abutting portion 131, the engaging portion 132, and the connecting portion oscillate up and down respectively when the lever 13 is shifted between the first position and the second position.

Please refer to FIG. 2. The presser 12 is pivoted to the rotary base, more particularly, on the shifting shaft 82, so that the presser 12 is able to rotate about the shifting shaft 82. The presser 12 is further mounted to the distal end of the connecting portion by insertion of the pin 14. Thus, the lever 13 swings together with the presser 12 when the presser oscillates up and down. The pin 14 is located between the shifting shaft 82 and distal end of the presser 12 which is located away from the shifting shaft 82.

The shifting member 11 is disposed on the rotary base and is able to slide horizontally. In addition, the shifting member 11 is disposed on the shifting shaft 82. Thus, the shifting member 11 and the shifting shaft 82 achieve an operation relationship. The shifting member 11 slides together with the shifting shaft 82 when the shifting shaft 82 slides.

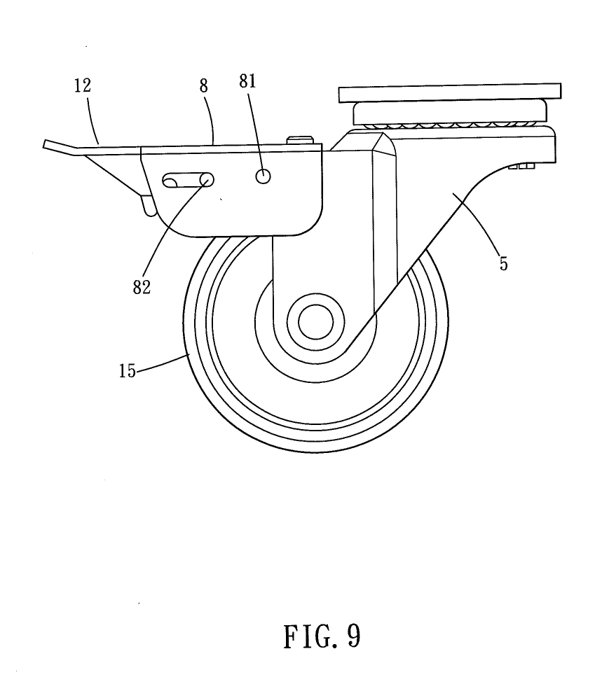

Please refer to FIG. 8 and FIG. 9. When the lever 13 is located at the first position, the abutting portion 131 is spaced apart from the wheel, and the abutting portion 132 is spaced apart from the fixation base. The rotary base and the wheel can rotate without obstruction. Function of movement is then provided. In the condition, connecting portion of the lever 13 pushes the presser 12 upwardly, and the shifting shaft 82 is located at the inner position.

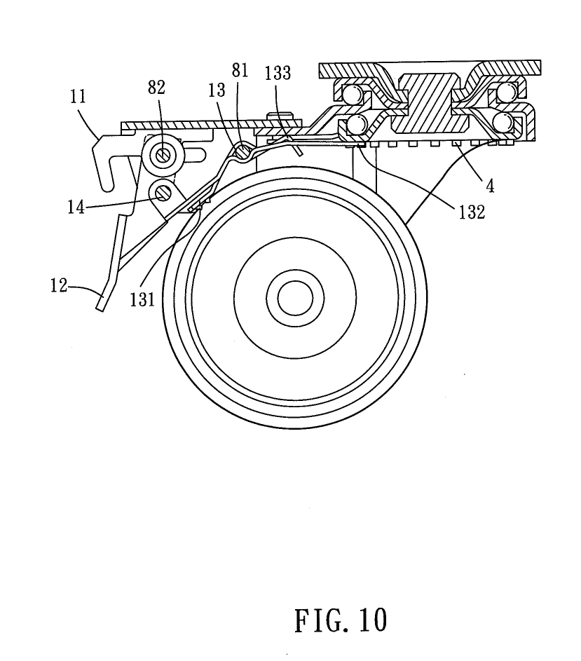

Please refer to FIG. 10. For activating the brake, the presser 12 is pressed downwardly. The presser 12 swings downwardly, shifting the lever 13 to the second position. The abutting portion 131 abuts against the wheel, and the engaging portion engages with the fixation base. In particular, the abutting portion 131 has toothed protrusions which press against outer surface of the wheel so as to prevent slipping. The engaging portion 132 has toothed and elongated protrusions which insert gaps defined by the protrusions 4 of the fixation base 1 so as to prevent rotation of the rotary base. The pin 14 is moved downwardly when the presser 12 swings downwardly. The shifting shaft 82 is then pushed to slide toward the distal end of the presser 12 to the outer position. The shifting shaft 82 is kept above the pin 14, so that the presser 12 would not recovery upwardly by the elastic force of the positioning portion 133 of the lever.

To release the brake mechanism, the shifting member 11 can be pushed inwardly. The shifting shaft 82 would slide toward the inner position. The presser 12 and the lever 13 are then recovered by the elastic force provided by the positioning portion 133. Positions of the components are then recovered as shown in FIG. 8.

Accordingly, when the brake mechanism is activated, both of the rotary base and the wheel are obstructed. The wheel is unable to roll, and also unable to spin. Thus, stably fixation function is realized.

In addition, when activating the brake mechanism, not only the presser 12 swings downwardly but the shifting shaft 82 slides outwardly. Thus, the presser 12 would be almost vertical in activating the brake mechanism, as shown in FIG. 10. Thus, space occupied by the caster assembly is minimized in brake activated condition.

What is claimed is:

1. A caster assembly, comprising:
a fixation base;
a rotary base, rotatably disposed on the fixation base, the rotary base being able to rotate about a non-horizontal axis;
a wheel, rotatably disposed on the rotary base, the wheel being able to rotate about a horizontal axis;
a brake mechanism, disposed on the rotary base, the brake mechanism being used for selectively abutting against the fixation base and the wheel, so that the rotary base and the wheel are unable to rotate.

2. The caster assembly of claim 1, wherein the brake mechanism comprises a lever, the lever pivots about a support shaft, so that the lever is able to be shifted between a first position and a second position, the lever has an abutting portion and an engaging portion, the support shaft is located between the abutting portion and the engaging portion, the abutting portion is spaced apart from the wheel and the engaging portion is spaced apart from the fixation base when the lever is located at the first position, the abutting portion abuts against the wheel and the engaging portion engages with the fixation base when the lever is located at the second position, so that movements of the wheel and the rotary base are obstructed.

3. The caster assembly of claim 2, wherein the support shaft is parallel to the horizontal axis, the abutting portion and the engaging portion oscillate up and down when the lever shifts between the first position and the second position, the brake mechanism further comprises a presser, the presser is disposed on the rotary base, the presser is able to oscillate up and down, the lever is shifted to the second position when the presser swings downwardly.

4. The caster assembly of claim 3, wherein the lever has a connecting portion extending therefrom, a distal end of the connecting portion is mounted to the presser, so that the connecting portion swings downwardly together with the presser when the presser swings downwardly.

5. The caster assembly of claim 3, wherein the presser pivots about a shifting shaft, the shifting shaft is parallel to the horizontal axis, the shifting shaft is able to move horizontally between an inner position and an outer position, the shifting shaft moves toward a distal end of the presser to the outer position when the presser swings downwardly.

6. The caster assembly of claim 5, wherein the brake mechanism further comprises a shifting member which is disposed on the rotary base and is able to slide horizontally, the shifting member and the shifting shaft achieve an operation relationship.

7. The caster assembly of claim 2, wherein the fixation has plural protrusions, the protrusions are annularly arranged about the non-horizontal axis, the engaging portion inserts at least one of gaps defined between any two adjacent protrusions.

8. The caster assembly of claim 3, wherein the fixation has plural protrusions, the protrusions are annularly arranged about the non-horizontal axis, the engaging portion inserts at least one of gaps defined between any two adjacent protrusions.

9. The caster assembly of claim 4, wherein the fixation has plural protrusions, the protrusions are annularly arranged about the non-horizontal axis, the engaging portion inserts at least one of gaps defined between any two adjacent protrusions.

10. The caster assembly of claim 5, wherein the fixation has plural protrusions, the protrusions are annularly arranged about the non-horizontal axis, the engaging portion inserts at least one of gaps defined between any two adjacent protrusions.

11. The caster assembly of claim 6, wherein the fixation has plural protrusions, the protrusions are annularly arranged about the non-horizontal axis, the engaging portion inserts at least one of gaps defined between any two adjacent protrusions.
